(19) United States
(12) Patent Application Publication
(10) Pub. No.: US 2014/0247513 A1
(43) Pub. Date: Sep. 4, 2014

(54) ENVIRONMENTAL DATA RECORD

(71) Applicants: Michael S. Bunker, Tomball, TX (US); Michael White, Houston, TX (US)

(72) Inventors: Michael S. Bunker, Tomball, TX (US); Michael White, Houston, TX (US)

(21) Appl. No.: 14/349,675

(22) PCT Filed: Oct. 25, 2011
(86) PCT No.: PCT/US11/57613

§ 371 Date: Apr. 4, 2014

(51) Int. Cl. G11B 20/18

(52) U.S. Cl. CPC G11B 20/18
USPC 360/6

(57) ABSTRACT

A drive assembly includes a memory device and a computing device communicatively coupled to the memory device. The computing device is to receive environmental data from a host device via a second communication channel isolated from a first communication channel and record the environmental data on the memory device.

### BACKGROUND

Today's immense demand for data storage has created a need for systems that can store large amounts of data. To this end, chassis have been developed to accommodate a plurality of drives such as hard disk drives (HDD). Each drive is typically disposed within a drive carrier and inserted into a drive bay of the chassis via guide rails. The drive carrier typically serves to lock and hold the drive in a particular position within the chassis, and to protect the drive from, e.g., electromagnetic energy interference (EMI) which may be caused by the neighboring drives.

### BRIEF DESCRIPTION OF THE DRAWINGS

Certain exemplary embodiments are described in the following detailed description and in reference to the drawings, in which:

FIG. 1 is a block diagram of a system in accordance with embodiments;

FIG. 2 is a process flow diagram of a method for recording environmental data in accordance with embodiments;

FIG. 3 is a block diagram of a system in accordance with embodiments;

FIG. 4 is a graphical representation of a substrate in accordance with embodiments;

FIG. 5. is a graphical representation of a substrate affixed to a drive carrier in accordance with embodiments; and

FIG. 6 is a process flow diagram of a method for recording environmental data in accordance with embodiments.

### DETAILED DESCRIPTION

Many of today's drives include indicators on the front bezel of the drive carrier to provide the customer with drive status information. In particular, one common drive indicator provides information as to whether or not a drive is operating correctly by illuminating different colors. In response to an indication that a drive is not operating correctly, customers typically return the drive to the manufacturer and assert that the drive is not operating properly. Upon testing the drive, however, the manufacturer commonly finds that the drive has no fault. In fact, nearly half the drives returned to some manufacturers are classified as “No Fault Found.” In such a situation, it is frequently the case that the drive failure indication occurred due to environmental system issues unrelated to the drive itself. For example, the drive failure indication may have been triggered by faulty array controller firmware, a faulty input/output module, a link error, or other environmental faults not specific to the drive itself. These issues are commonly rectified by simply removing the drive from the environment. That is, by the time the drive is sent back to the manufacturer and tested, the issue that caused the failure indication is no longer present and the drive tests as healthy.

Likewise, drive failure indications commonly occur when a drive locks-up. These errors are commonly rectified by simply power cycling the drive. Consequently, when the drive is returned by the customer to the manufacturer, the drive tests as healthy because it has been power cycled via the return process.

In addition to returned drives testing healthy, manufacturers commonly note that there is no stored information on the drive as to the cause of the failure. This may occur for at least two reasons. First, in the case of an environmental failure (e.g., faulty array controller firmware, a faulty input/output module, a link error, etc.), such faults are outside the potential monitoring capability of the drive. That is, any potential drive monitoring log is very limited and does not record environmental faults. Second, in the case of a locked-up drive, any potential drive monitoring log does not include any information about the fault because, by virtue of the drive locking-up, the media to record information was inaccessible. Said differently, a host cannot access the media to record information because the communication path between the host and the log is disabled due to the drive locking-up.

The above-described issues are financially detrimental to a manufacturer because the manufacturer must expend time, labor, and materials to test drives that may be healthy. More frustrating, the manufacture cannot pinpoint the trigger of the error indication because the cause was outside the monitoring capability of the drive or the media to record such information was inaccessible. The manufacturer, therefore, cannot effectively and effectively prevent further similar occurrences. For example, if another manufacturer's array controller is the source of the failure, the manufacturer cannot easily identify and rectify the problem because the cause of the failure was outside the monitoring capability of the drive and therefore difficult to identify. Similarly, if the actual drive is the source of the problem (e.g., the drive locked-up), the manufacturer cannot easily identify and rectify the problem because the communication channel between the host and drive was blocked due to the drive locking-up.

Embodiments described herein may address at least the above-described issues by providing a drive assembly that records environmental data via a secondary communication channel isolated from a primary communication channel. The type of environmental data recorded as well as the communication path to record such data is previously unforeseen in the drive assembly market. Moreover, the location of where the data is recorded, the manner by which the data is recorded, and the configuration of the drive assembly and drive carrier are previously unforeseen in the marketplace.

The capability to record environmental data as described in embodiments may enable manufacturers to identify and understand the cause of a failure indication, and therefore enable modifications to be made to prevent further similar occurrences. For example, if the source of the failure indication is a faulty array controller, the manufacturer can work with the array controller manufacturer to modify the array controller so that the array controller does not trigger further drive failure indications. As a result, less drives may be returned to the manufacturer by customers.

In one embodiment, a drive assembly for recording environmental data is disclosed. The drive assembly comprises a memory device and a computing device communicatively coupled to the memory device. The computing device is configured to receive environmental data from a host device via a second communication channel isolated from a first communication channel that communicatively couples the host device and a drive of the drive assembly. The computing device is further configured to record the environmental data received over the second communication channel on the memory device. In some embodiments, the memory device and computing device are located on a substrate affixed to a drive carrier of the drive assembly. Additionally, in some embodiments, the memory device and computing device are integrated into a single device located on a substrate affixed to a drive carrier of the drive assembly.

In another embodiment, a method for recording environmental data is disclosed. The method comprises receiving, at a computing device of a drive assembly, environmental data from a host device via a second communication channel isolated from a first communication channel, and recording the environmental data on the memory device. The first communication channel may communicatively couple the host device and a drive of the drive assembly, and may be used to communicate read and write commands from the host device to the drive.

In a further embodiment, a drive carrier for recording environmental data is disclosed. The drive carrier comprises a substrate coupled to the drive carrier, a memory device located on the substrate, and a computing device located on the substrate and communicatively coupled to the memory device. The computing device is configured to receive environmental data from a host device over a communication channel and record the environmental data on the memory device. In embodiments, the memory device and the computing device may be integrated into a single device located on the substrate coupled to the drive carrier. In additional embodiments, the substrate is a flexible printed circuit board affixed to the drive carrier. In still further embodiments, the communication channel is a second communication channel isolated from a first communication channel that is used to communicate read and write commands from a host device to the a drive associated with the drive carrier.

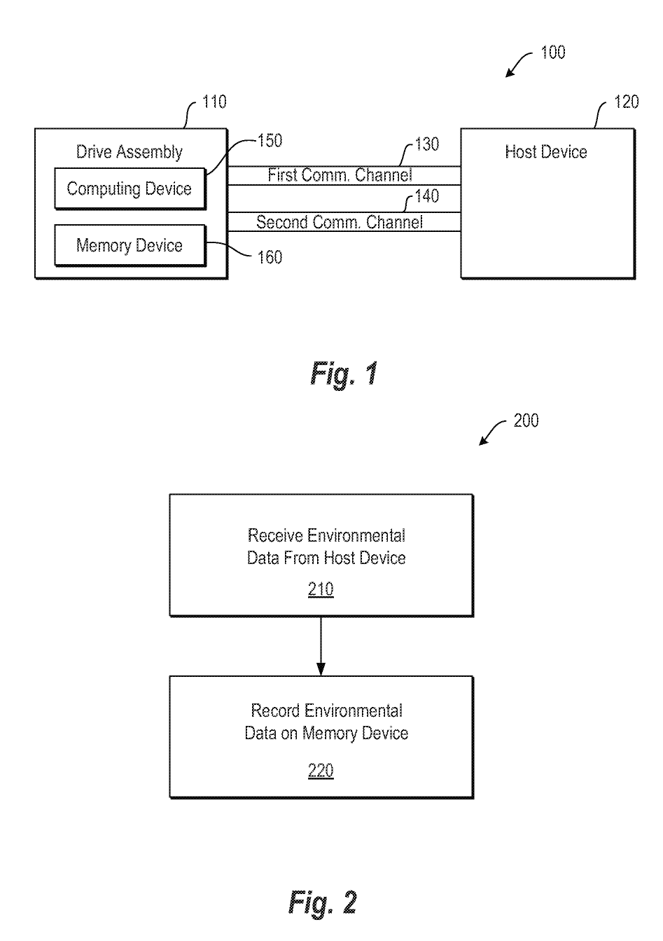

FIG. 1 is a block diagram of a system 100 in accordance with embodiments. The system 100 may include a drive assembly 110, a host device 120, a first communication channel 130, and a second communication channel 140.

The drive assembly 110 may comprise a computing device 150 and a memory device 160. While shown as two separate devices, in some embodiments, the computing device 150 and the memory device 160 may be integrated into a single device (e.g., a microcontroller with on-board non-volatile memory). The drive assembly 110 may further comprise a drive, a drive carrier, and/or an interposer board (not shown). In embodiments, the computing device 150 and/or the memory device 160 may be located on the drive, the drive carrier, and/or the interposer board. The drive carrier, as discussed in greater detail below, may be a partial enclosure or casing for the drive. The drive carrier may be constructed of plastic, metal, and/or other materials. The drive may be, for example, a hard disk drive (HDD), a solid state drive (SSD), or a hybrid drive. The interposer board may be a board with electronics disposed thereon located between, e.g., the drive and a backplane.

The host device 120 may be, for example, a disk array controller, a redundant array of independent disks (RAID) controller, a disk controller, a host bus adapter, an expander, a server, an operating system (OS) driver, a Serial Attached ACSI (SAS) expander, or a computing device associated therewith. The host device 120 may comprise a processor (not shown) which executes instructions stored on an associated computer-readable medium such as a memory (not shown) to effectuate the host device functionality described herein. The host device 120 may further comprise at least one communication interface (not shown) for communicating with, e.g., the computing device 150 within the drive carrier assembly 110 and/or the drive within the drive carrier assembly 110.

The host device 120 may communicate with the drive carrier assembly 110 via a first communication channel 130 and a second communication channel 140. More specifically, the host device 120 may communicate with a drive of the drive carrier assembly 110 via a first communication channel 130 and may communicate with the computing device 150 of the drive carrier assembly 110 via the second communication channel 140. The first communication channel 130 and a secondary communication channel may be isolated communication paths. For example, in embodiments, the first communication channel 130 may not be used to communicate with the computing device 150, and the second communication channel may not be used to communicate with the hard drive. The first communication channel 130 may be used for, among other things, communicating read/write commands from the host device 120 to the hard drive. By contrast, in embodiments, the second communication channel may not be used to communicate read/write commands from the host device 120 to the hard drive. The first communication channel 130 may be, for example, a SAS, a serial advanced technology attachment (SATA), or a fibre communication channel/bus interconnecting the host device 120 and hard drive. The second communication channel 140 may use similar technologies, but may also use an inter-integrated circuit (I2C) communication bus to interconnect the host device 120 and the computing device 150.

In general, the first communication channel 130 may be understood as the drive communication channel for communicating read/write commands and corresponding data between the host device 120 and the hard drive. The second communication channel 140, by contrast, may be understood as a separate and isolated channel to communicate data between the host device 120 and the computing device 120. That is, the second communication channel 140 is not used to communicate read/write commands and corresponding data between the host device 120 and the hard drive. Rather, the second communication channel may be used to conduct additional features such as, e.g., detecting the backplane type/size, detecting if the drive is installed, enumerating the box and bay location of the drive, authenticating the drive carrier, controlling LED states except for activity, flashing the firmware on the drive carrier, and/or writing/reading/locking computing device 150 contents. Said differently, the second communication channel 140 may be used to conduct “secondary” processes other than writing data to and/or reading data from the drive. Furthermore, the second communication channel 140 may not be dependent upon a functional drive. Thus, if the drive lock-up or otherwise fails, the host device 120 may continue to communicate with the computing device 150 and associated memory 160 via the second communication channel 140.

The computing device 150 may write data to the memory device 160 of the drive assembly 110. In embodiments, the data may originate from the host device 120 and be transmitted to the computing device via the second communication channel 140. The data may be transmitted once, periodically, and/or in response to an event. Such events may be, for example, the initiation of the host device 120 (e.g., boot-up), the detection of a drive hot-plugged into the chassis by the host device 120, the detection of a predictive failure event by the host device, and/or the detection of a drive failure by the host device 120. As used herein, a “drive failure” means that the drive has failed and/or that the host device 120 has determined that the drive has failed. In contrast, a “predictive drive failure” means that the drive may fail in the future and/or that the host device 120 has detected that the drive may fail in the future (e.g., the host device 120 detects that a drive attribute is out of specification).

The data written to memory device 160 may be data about the drive carrier assembly 110 environment. For example, the data may include manufacturing/main information, controller information, enclosure information, and/or target information. The manufacturing/main information may include, e.g., the record version of the memory device 160 content, the version of the application firmware executing on the computing device 160, the checksum, the factory test results, the country of origin, and/or the last LED state sent to computing device 150. The controller information may include, e.g., attached server information (server serial number), controller information (vendor identifier, device identifier, and/or firmware revision number). RAID setting information, number of logical drives on the physical drive information, number of physical drives in a RAID set of which the drive is a member information, total number of drives present at time of failure information, the logical drive number of the largest logical drive information, the stripe size of the largest logical drive information, the number of expanders in the topology information, connection rate information, hot plug count information, the number of drives belonging to the array, and drive failure codes (e.g., different codes for different device failures and predictive failures). The enclosure information may include, e.g., attached backplane information, fan status information, power supply information, and temperature information. The target information may include, e.g., drive model number information, drive firmware revision information, drive serial number information, controller port number information, box number information, bay number information, number of expander hops to target information, device power-on minutes, last read of device temperature, drive location, last temperature sensed, and/or error codes.

Such environmental data may be written to the memory device 160 via the computing device 150. Upon extraction, the environmental data may enable manufacturers to better understand the cause of a failure indication. Such environmental data may be written via the second communication channel 140 which is not dependent upon a functional drive. Accordingly, the host device 120 (e.g., an array controller) may have a separate communication channel to store failure information on the drive assembly 110 that is isolated for the hard drive SAS/SATA communication channel and not dependent upon a functional drive. This allows the host device 120, who may ultimately be in charge of determining whether a drive failure has occurred, to record why the host device 120 failed the drive along with telemetry information about the system.

FIG. 2 is a process flow diagram of a method for recording environmental data in accordance with embodiments. The method 200 may be performed by the computing device 150 of the drive carrier assembly 110 as shown in FIG. 1.

The method may begin at block 210, where the computing device 110 receives environmental data from a host device 120 via a second communication channel 140 isolated from a first communication channel 130. The second communication channel 140 may be independent of the first communication channel 130 and may not depend upon a functioning drive. The first communication channel 130 may communicatively couple the host device 120 and a drive of the drive assembly 110 (e.g., SAS/SATA drive communication fabric). In some embodiments, the second communication channel 140 may be an inter-integrated circuit (I2C) communication bus. Furthermore, in embodiments, the computing device 150 may receive the environmental data in response to the host device 120 detecting a failure or predictive failure. The computing device 150 may also receive the environmental data in response to host device 120 initiation, or in response to the host assembly being hot-plugged into the chassis. The environmental data may comprise, e.g., a reason for a failure or a reason for a predictive failure.

At block 220, the computing device 150 may record the environmental data on the memory device 160. The environmental data may be recorded on the memory device 160 as, for example, dynamic data or static data.

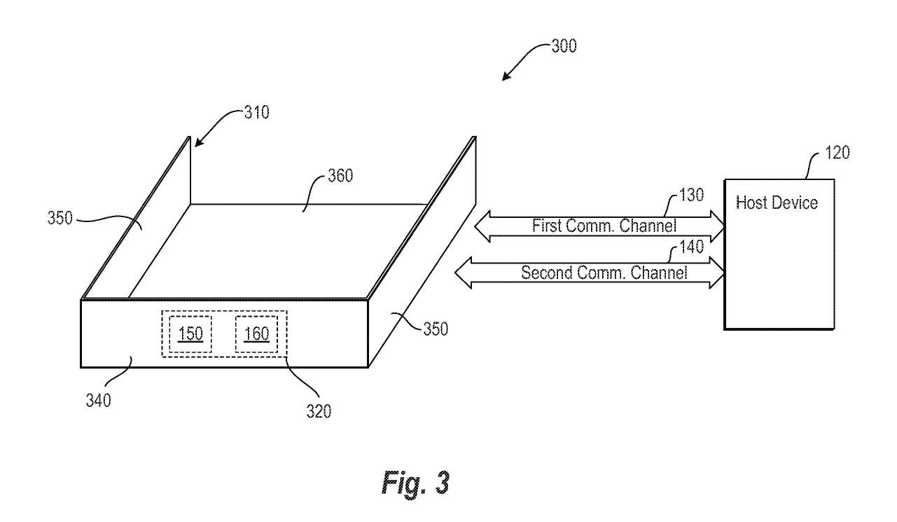

FIG. 3 is a block diagram of a system in accordance with embodiments. The system 300 comprises a drive carrier 310, a host device 120, a first communication channel 130, and a second communication channel 140.

The drive carrier 310 may have attached thereto a substrate 320 with a computing device 150 and a memory device 160 affixed thereon. The substrate 320 may be, for example, a rigid and/or flexible printed circuit board (PBC). The computing device 150 may be, for example, a microcontroller, microprocessor, processor, expander, driver, and/or computer-programmable logic device (CPLD). The memory device 160 may be, for example, a non-volatile memory (NVRAM), a flash memory, an erasable programmable read-only memory (EEPROM), or the like. While shown as two separate devices, in embodiments, the computing device 150 and memory device 160 may be integrated into a single device in embodiments (e.g., a microcontroller with on-board NVRAM).

The drive carrier 310 may be constructed of plastic, metal, and/or other materials. It may include a front plate or bezel 340, opposing sidewalls 350, and a floor 360. A drive (not shown), such as a hard disk drive (HDD), solid state drive (SSD), or hybrid drive, may be placed within and/or attached to the area formed by the opposing sidewalls 350, floor 360, and front plate 340. The HDD may use spinning disks and movable read/write heads. The SSD may use solid state memory to store persistent data, and use microchips to retain data in non-volatile memory chips. The hybrid drive may combine features of the HDD and SSD into one unit containing a large HDD with a smaller SSD cache to improve performance of frequently accessed files. Other types of drives such as flash-based SSDs, enterprise flash drives (EFDs), etc. may also be used with the drive carrier 310.

The host device 120 may be, for example, a disk array controller, a redundant array of independent disks (RAID) controller, a disk controller, a host bus adapter, an expander, a server, an operating system (OS) driver, or a Serial Attached ACSI (SAS) expander. The host device 120 may comprise a processor (not shown) which executes instructions stored on an associated computer-readable medium such as a memory (not shown) to effectuate the host device functionality described herein. The host device 120 may further comprise one or more communication interfaces (not shown) for communicating with, e.g., the drive (not shown) via the first communication channel and the computing device 130 via the second communication channel 140.

The first communication channel 130 may be, for example, a SAS, a serial advanced technology attachment (SATA), or fibre communication channel/bus. The first communication channel 130 may be used by the host device 120 to write data to or read data from the drive (not shown). By contrast, the second communication channel 140 interconnecting the host device 120 and the computing device 150 may be, for example, a serial bus such as an inter-integrated circuit (I2C) communication bus isolated from the first communication channel 130 and configured to be used by the host device to perform “secondary” features such as detecting the backplane type/size, detecting if the drive is installed, enumerating the box and bay location of the drive, authenticating the drive carrier, controlling LED states except for activity, flashing the firmware on the drive carrier, and/or writing, reading, and locking computing device 150 contents. Said differently, the second communication channel 140 may be used to conduct processes other than writing data to and/or reading data from the drive. Furthermore, the second communication channel 140 may not be dependent upon a functional drive. Thus, if the drive locks-up or otherwise fails, the host device 120 may continue to communicate with the computing device 150 and memory 160 via the second communication channel 140.

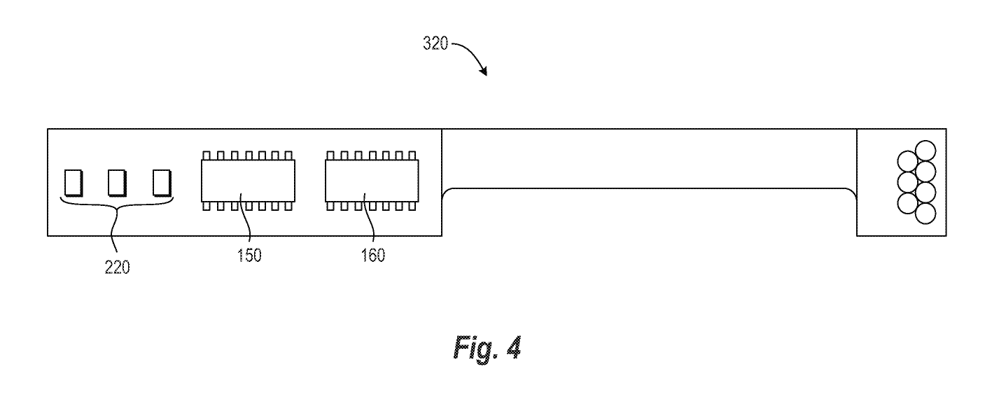

FIG. 4 is a graphical representation of a substrate 320 in accordance with embodiments. In particular, FIG. 4 depicts a substrate 320 with a computing device 150 and memory device 160 affixed thereon. The computing device 150 may be configured to write data to the memory device 160 based on information received from host device 120, as well as conduct other operations such as controlling light sources 410 based on commands from the host device 120. In embodiments, the computing device 150 and memory device 160 may be integrated into a single device. Furthermore, in embodiments, the substrate 320 may be a flexible and/or rigid printed circuit board.

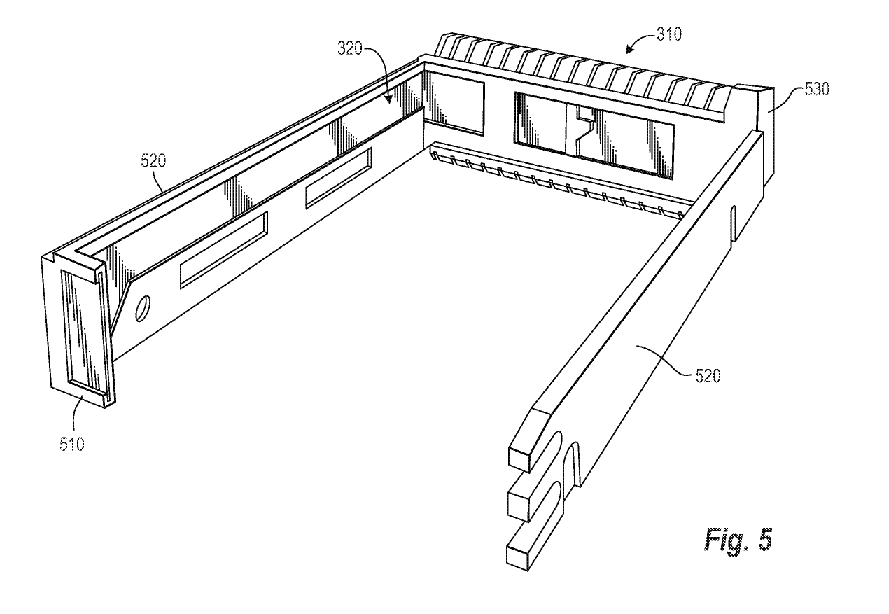

FIG. 5. is a graphical representation of how the substrate 320 of FIG. 4 may be affixed to the drive carrier 310 in accordance with embodiments. As shown, the substrate 320 may be a flexible printed circuit board 210 coupled to the rear of the drive carrier 510, one of the opposing sidewalls 520, and/or the front of the drive carrier 530. Of course, alternate configurations may also be used in accordance with embodiments. For example, in embodiments, a rigid printed circuit board may be affixed to the rear of the drive carrier 510, one of the opposing sides 520, and/or the front of the drive carrier 530. Further, in embodiments, a combined rigid and flexible printed circuit board may be affixed to the rear of the drive carrier 510, one of the opposing sides 520, and/or the front of the drive carrier 530.

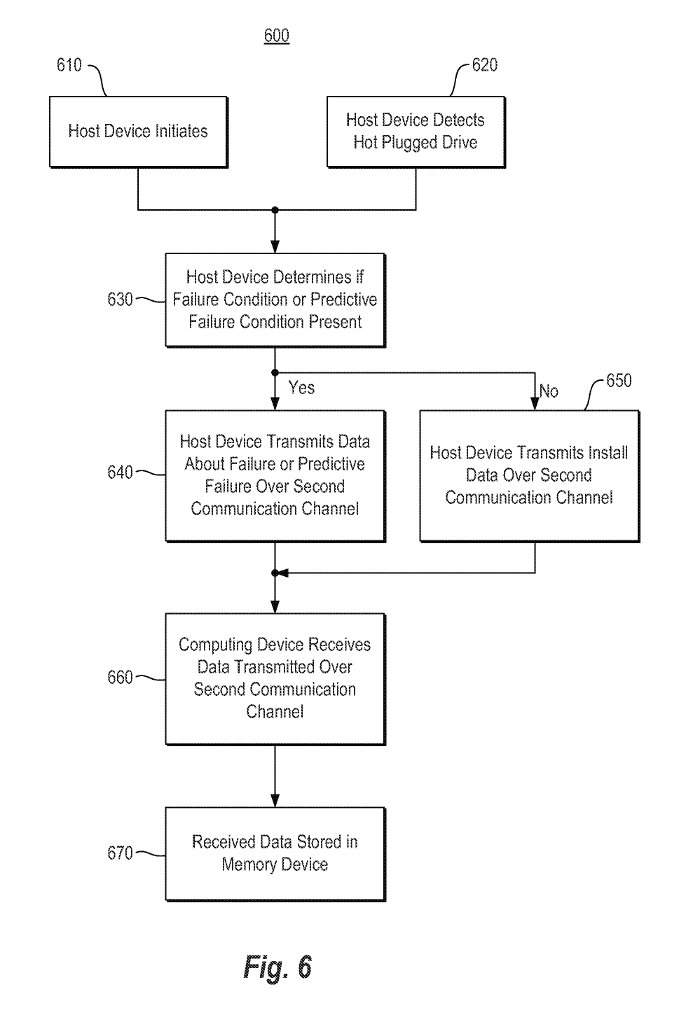

FIG. 6 is a process flow diagram of a method for recording environmental data in accordance with embodiments. The method 600 may be performed by the host device 120, the computing device 150, and the memory device 160, as referenced in FIG. 1.

The method 600 may begin at either block 610 or block 620. At block 610, the host device powers-up, boots-up, or is otherwise initiated. At block 620, a drive is hot-added or hot-plugged into a chassis. The occurrence of either of the events specified in block 610 or block 620 leads the host device 120 to determine if a failure condition or predictive failure condition exists at block 630. Stated differently, whenever the host device initiates or a drive is hot-plugged, the host device 120 checks if there is a drive failure or a predictive failure. If a drive failure or predictive failure condition exists, the host device 120 transmits information about the drive failure or predictive failure over the second communication channel 140 at block 640. The information may include, for example, a reason for the failure determination (e.g., a failure code), a reason for the predictive failure determination (e.g., a predictive failure code), a time, and/or a date. If a drive failure or predictive failure condition does not exist, at block 650, the host device 120 transmits “install data” over the second communication channel 140. This install data may be, for example, information indicating that the drive is running properly and a time/date. In some embodiments, the install data is transmitted over the second communication channel 140 regardless of whether or not a failure or predictive failure exists.

At block 660, the computing device 150 receives the data transmitted over the second communication channel 140 from the host device 120. The computing device 150 then, at block 670, causes the data to be stored in memory device 160. Of course, as mentioned above, the computing device 150 and memory device 160 may be integrated into a single device. Therefore, the same device may receive and store the data.

It should be understood that the processes shown in FIG. 6 are not limiting. For example, the host device 120 may transmit information to the computing device 150 in response to events other than those described in FIG. 6. For instance, information may be transmitted periodically from the host device to the computing device 150 to be recorded on the memory device 160 in some embodiments. Additionally, information other than install data, failure information, and/or predictive failure information may be transmitted over the second communication channel 140. For example, information may be transmitted such as the last LED state sent to the computing device 150. RAID setting information, temperature information, fan status information, drive location information, and the like.

Furthermore, it should be understood that the host device 120 and/or computing device 150 may include a non-transitory, computer-readable medium that stores code for operating a host device 120 and/or computing device 150 in accordance with the above-described embodiments. The non-transitory, computer-readable medium may correspond to any typical storage device that stores computer-implemented instructions, such as programming code or the like. For example, the non-transitory, computer-readable medium may include one or more of a non-volatile memory, a volatile memory, and/or one or more storage devices. Examples of non-volatile memory include, but are not limited to, electronically erasable programmable read only memory (EEPROM), flash memory, and read only memory (ROM). Examples of volatile memory include, but are not limited to, static random access memory (SRAM) and dynamic random access memory (DRAM). Examples of storage devices include, but are not limited to, hard disk drives, compact disc drives, digital versatile disc drives, optical drive, and flash memory devices. A processor may generally retrieve and execute the instructions stored in the non-transitory, computer-readable medium to operate the host device 120 and/or computing device 150 in accordance with the above-described embodiments.

What is claimed is:

1. A drive assembly for recording environmental data, comprising:
a memory device; and
a computing device communicatively coupled to the memory device, wherein the computing device is to
receive environmental data from a host device via a second communication channel isolated from a first communication channel, wherein the first communication channel communicatively couples the host device and a drive of the drive assembly; and
record the environmental data on the memory device.

2. The drive assembly of claim 1, wherein the memory device and the computing device are located on a substrate affixed to a drive carrier of the drive assembly.

3. The drive assembly of claim 1, wherein the memory device and the computing device are integrated into a single device located on a substrate affixed to a drive carrier of the drive carrier assembly.

4. The drive assembly of claim 1, wherein the first communication channel is to communicate read and write commands from the host device to the drive.

5. The drive assembly of claim 1, wherein the environmental data comprises drive assembly manufacturing information, redundant array of independent disks (RAID) configuration information, temperature information, failure information, or predictive failure information.

6. The drive assembly of claim 1, wherein the computing device is to receive the environmental data after the host device detects a failure or a predictive failure.

7. The drive assembly of claim 1, wherein the computing device is to receive the environmental data after the host device initiates or after the drive assembly is hot-plugged into a chassis.

8. The drive assembly of claim 1, wherein the host device is a disk array controller, a redundant array of independent disks (RAID) controller, a disk controller, a host bus adapter, an expander, a server, an operating system (OS) driver, or a Serial Attached ACSI (SAS) expander.

9. A method for recording environmental data, comprising:
receiving, at a computing device of a drive assembly, environmental data from a host device via a second communication channel isolated from a first communication channel, wherein the first communication channel communicatively couples the host device and a drive of the drive assembly; and
recording, by the computing device, the environmental data on a memory device.

10. The method of claim 9, wherein the receiving occurs in response to the host device detecting a failure or predictive failure.

11. The method of claim 9, wherein the receiving occurs in response to the host device initiating or the drive assembly being hot-plugged into a chassis.

12. The method of claim 9, wherein the environmental data comprises a reason for a failure or a reason for a predictive failure.

13. A drive carrier for recording environmental data, comprising:
a substrate coupled to the drive carrier;
a memory device located on the substrate; and
a computing device located on the substrate and communicatively coupled to the memory device, wherein the computing device is to
receive environmental data from a host device over a communication channel; and
record the environmental data on the memory device.

14. The drive carrier of claim 13, wherein the memory device and the computing device are integrated into a single device.

15. The drive carrier of claim 13, wherein the communication channel is a second communication channel isolated from a first communication channel that is used to communicate read and write commands from the host device to a drive associated with the drive carrier.
